(19) United States
(12) Patent Application Publication
(10) Pub. No.: US 2026/0147880 A1
(43) Pub. Date: May 28, 2026

(54) DETECTION ENGINE(S) FOR IDENTIFYING BOT-CREATED TENANTS WITHIN A CLOUD-BASED ENVIRONMENT

(71) Applicant: Microsoft Technology Licensing, LLC, Redmond, WA (US)

(72) Inventors: Zheng YANG, Atlanta, GA (US); Beibei CHENG, Bellevue, WA (US); Cormac HERLEY, Bellevue, WA (US); Anna Swanson BERTIGER, Seattle, WA (US); Sergio ROMERO ZAMBRANO, Seattle, WA (US); Michael Vincent MCLAUGHLIN, Seattle, WA (US)

(21) Appl. No.: 18/957,534

(22) Filed: Nov. 22, 2024

(51) Int. Cl. G06F 21/55

(52) U.S. Cl. CPC G06F 21/554; G06F 2221/034

(57) ABSTRACT

Systems and methods herein provide a detection engine and its related functions. In an aspect, a detection engine determines tenants associated with a service within a cloud-based or hybrid environment and determines a plurality of resources associated with the tenants. Based on the resources, the detection engine determines a relational similarity between a first subset of tenants, such as by clustering the tenants into groups indicating related resources. From the grouping, the detection engine determines a first group of tenants contains bot-created tenants. Subsequently, the detection engine submits the first group of tenants as input into a neural network model to determine whether the tenants within the first group are legitimate or bot-created. Based on the output from the neural network model, the detection engine identifies the bot-created tenants within the first group, as well as any legitimate tenants present therein.

### TECHNICAL FIELD

Aspects of the disclosure are related to the field of computer software applications and services and, in particular, to detection engines for identifying bot-created tenants within a cloud-based environment.

### BACKGROUND

As the modern era increasingly transitions into cloud-based environments, the prevalence of bot-created tenants has surged, posing unique challenges for digital infrastructure. A bot-created tenant is an account, instance, or entity within a cloud environment that has been automatically generated by bots—automated programs that mimic human behavior. These bots may create tenants for various purposes, from testing vulnerabilities and accessing services to performing malicious activities. Bot-created tenants often consume valuable resources, compromise system performance, and increase security risks within the cloud. Their proliferation can lead to increased operational costs, decreased efficiency, and the potential for data breaches, making the detection and management of bot-created tenants a critical focus for cloud-based services and cybersecurity teams alike.

### SUMMARY

Technology disclosed herein includes software applications and services that provide a detection engine, and its related functions. In an aspect, a detection engine determines tenants accessing a service provided within a cloud-based environment. The tenants may be tenants that have signed up or sign into the service provided by a cloud provider. Responsive to determining the tenants, the detection engine determines resources associated with the tenants. In an example, the resources include identity and/or access credentials associated with a given tenant, such as a username, email address, IP (Internet Protocol) address, or phone number.

Next, the detection engine determines a relational similarity between the tenants based on resources associated with the tenants. In an embodiment, the detection engine clusters the tenants into subsets of tenants based on shared resources. In an example, a cluster of tenants is a plurality of tenants having shared resources. These subsets or groups of tenants are referred to herein as clusters. From the clusters of tenants, the detection engine determines a potentially fraudulent cluster of tenants.

To ensure that legitimate tenants are not flagged as bot-created tenants, the detection engine then analyzes the tenants within the fraudulent cluster of tenants to identify which tenants are bot-created and which are legitimate. As used herein, a legitimate tenant is a tenant that is not bot-created. To distinguish between bot-created tenants and legitimate tenants, the detection engine leverages a neural network model that is trained to recognize patterns and nuances in information associated with a given tenant. This information includes service access information and resources associated with a given tenant. As expanded on below, the detection engine generates an input for the neural network model based on the service access information, and in some cases the resources, associated with a respective tenant, and submits the input into the neural network model, which responsively generates a score indicating the likelihood that the respective tenant is bot-created or legitimate.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing a detection engine, according to an embodiment herein;

FIG. 2 illustrates an example system in which a detection engine is provided, according to an embodiment herein;

FIG. 3 illustrates a process for providing a detection engine and its related functions, according to an embodiment herein;

FIG. 4 illustrates an example visualization of a group of clusters generated by a detection engine, according to an embodiment herein;

FIG. 5 provides an example illustration of a neural network model, according to an embodiment herein;

FIG. 6 illustrates a visual representation identifying a bot-created tenant, according to an embodiment herein; and

FIG. 7 shows an example client device suitable for providing a detection engine and related functions, according to an embodiment herein.

### DETAILED DESCRIPTION

In the modern era, organizations and businesses are increasingly transitioning to cloud-based or hybrid environments to bring services to consumers. This shift enables companies to streamline operations, improve scalability, and enhance access to data and applications from virtually anywhere. Users typically gain access to these cloud-based services by creating accounts or tenants within the provider's platform. These tenants function as individualized spaces within the cloud infrastructure, granting each user or organization tailored access, data segregation, and specific resource allocations. Through these tenants, users can securely log in, manage their data, customize their services, and control various settings to fit their needs, while the cloud provider maintains the underlying infrastructure and security controls. This setup fosters a seamless experience, where consumers can access powerful tools and services without the need for extensive on-premises hardware or software.

As cloud-based environments continue to expand and evolve, the increasing prevalence of bot-created tenants has introduced new challenges for organizations striving to maintain control over their resources. Bot-created tenants are cloud accounts or environments automatically generated by bots or scripts, often without direct human oversight. While these automated tenants can serve legitimate purposes, they are frequently associated with undesirable outcomes, such as unauthorized resource usage, security vulnerabilities, and compliance issues. Unlike user-created tenants (i.e., legitimate tenants), which follow standard provisioning processes with clear permissions and controlled access levels, bot-created tenants can bypass typical oversight mechanisms, making them harder to track and secure. This can lead to problems like unexpected cost spikes from resource overuse, data privacy risks, and exploitable vulnerabilities. Additionally, bot-created tenants contribute to “cloud sprawl”—the proliferation of unmanaged accounts—which complicates resource management and inflates operational costs.

In some cases, bot-created tenants are generated with explicitly malicious intent, programmed to consume or exploit cloud-based services for unauthorized activities. These malicious tenants can be designed to leverage cloud resources for a range of illegal actions, including sending large volumes of spam emails, conducting credit card fraud, and creating virtual machines (VMs) for intensive cryptocurrency mining. Such activities exploit the cloud provider's infrastructure and resources, often racking up substantial costs and leading to potential service disruptions. Because these bots operate autonomously, they can rapidly create and discard tenants, making it difficult for traditional security measures to detect and mitigate their actions in real-time. These malicious bot-generated tenants not only drain organizational resources but also compromise the security and integrity of the cloud environment, exposing it to data breaches, potential regulatory non-compliance, and reputational damage.

Accordingly, given the potential risks and infrastructure burdens associated with bot-created tenants—both from unintentional resource sprawl and deliberate exploitation—detecting these automated tenants as early as possible is crucial for maintaining cloud security and cost-efficiency. Early detection allows a data centre or other cloud infrastructure to automatically isolate malicious or fraudulent bots, enables organizations to promptly disable suspicious tenants, preventing them from consuming excessive resources or engaging in malicious activities like spamming, credit card fraud, or crypto mining. Quick identification of bot-created tenants also helps avoid the ripple effects of cloud sprawl, reducing resource waste, minimizing unexpected costs, and ensuring the cloud environment remains organized and secure. By catching these bot-created tenants early, companies can safeguard their cloud infrastructure, protect sensitive data, and uphold compliance standards, creating a more secure and manageable cloud environment for legitimate users.

Conventional approaches to detecting bot-created tenants often rely on monitoring sudden spikes in activity within a short timeframe, as such bursts are typically associated with automated processes. However, this method has notable limitations. Bots programmed to evade detection can distribute their activity over a longer period, operating in a more gradual and inconspicuous manner that doesn't trigger standard alarms. As a result, these “low-and-slow” bot-created tenants can remain undetected, consuming resources and performing malicious tasks at a steady, seemingly normal rate. This evasion tactic not only allows harmful activities, like spam distribution or crypto mining, to go unnoticed but also contributes to cloud sprawl, driving up costs and compromising system integrity. Furthermore, reliance on high-activity detection can result in numerous false positives, flagging legitimate tenants experiencing natural usage increases, leading to inefficient allocation of security resources and unnecessary disruptions for users.

To address at least the shortcomings discussed above, an example detection engine is provided herein. In particular, a detection engine for identifying bot-created tenants within a cloud-based environment is described. As will be described in greater detail below, the detection engine considers tenant behavioral patterns over time, cross-tenant comparisons, and subtle anomalies on a per tenant bases to identify bot-created tenants effectively. For example, the detection engine identifies groups of tenants that share resources and then determines, based on a variety of information relating to each tenant, whether a respective tenant is a bot-created tenant. When a group of tenants is identified as sharing multiple resources—such as IP addresses, usernames, email addresses, payment information, physical or biometric data, geolocation data, and phone numbers—it often indicates a higher likelihood that some of these tenants are bot-created. This clustering of shared resources suggests coordinated or automated activity, which is common in bot-created tenants designed to exploit cloud services, evade detection, or execute malicious tasks in a synchronized manner.

However, this sharing of resources often mimics legitimate patterns within the cloud environment, and as such, once a group of tenants sharing resources is identified, the detection engine analyzes each tenant within the identified group to determine whether a respective tenant is bot-created or not. In some embodiments, to analyze whether a respective tenant is bot-created or not, the detection engine generates a variety of tenant features based on service access information of the tenant and submits these tenant features to a tenant classifier to generate a score indicating the likelihood that the respective tenant is bot-created or a legitimate tenant. In some cases, the tenant classifier is a machine learning model such as a support vector machine, random decision forest, neural network, or other classifier. As can be appreciated, identifying legitimate tenants within a suspected group of bot-created tenants is equally important as detecting bot-created tenants as it helps prevent disruptions to genuine user activity and maintain a seamless user experience.

The detection engine, by monitoring and identifying bot-created tenants in real time, aids in maintaining security, supports resource efficiency, and fosters user trust within cloud environments. Real-time detection provided by the detection engine allows organizations to address bot-created tenants as soon as they emerge, preventing unauthorized resource consumption, curbing security risks, and minimizing costs from fraudulent activity. This capability is particularly critical in defending against more sophisticated bot attacks, such as “slow and low” bots, which are programmed to spread their activity across extended periods to avoid detection by traditional monitoring tools. By identifying these stealthy bots, the detection engine can prevent prolonged resource exploitation, subtle data breaches, and potential compliance violations that might otherwise go unnoticed. Additionally, the real-time identification provided by the detection engine enables prompt response actions, helping organizations stay proactive in managing cloud sprawl and protecting legitimate users, all while maintaining the integrity and security of their infrastructure.

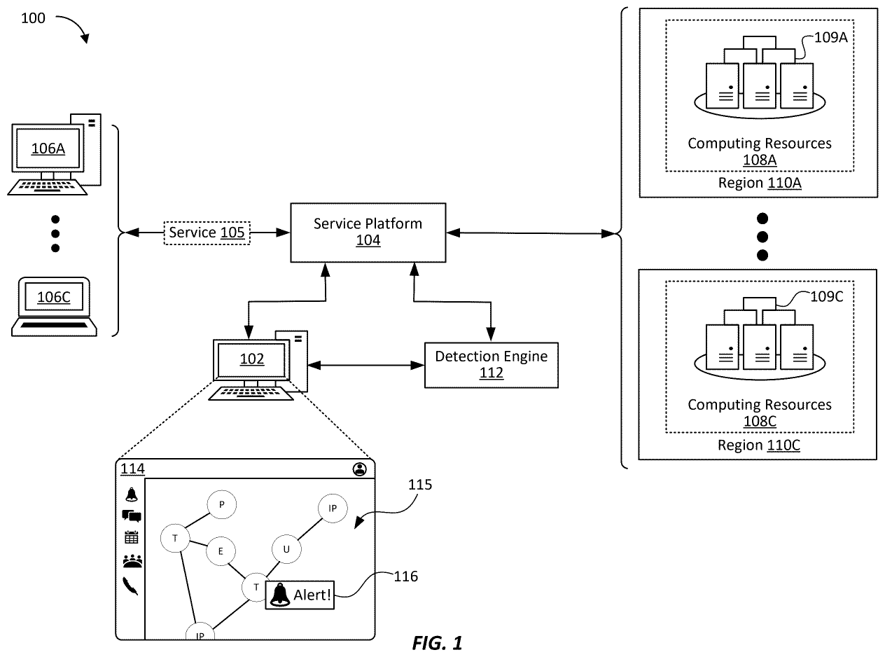

Turning now to the Figures, FIG. 1 illustrates an operational environment 100 for providing a detection engine 112, according to an embodiment herein. In particular, the environment 100 illustrates a service platform 104 delivering a service 105 to client devices 106A-C. The service platform 104, which may be associated with an organization or business, interacts with a service infrastructure to deliver the service 105 to client devices 106A-C, representing end-users or consumers of the service 105. This service may include various productivity applications, such as Microsoft Office, email services, or other software-as-a-service (SaaS) offerings, provided via the service platform 104. The service platform 104 acts as an intermediary, hosting and managing the necessary infrastructure to operate the service 105, ensuring its accessibility to client devices 106A-C over the internet or a network.

As illustrated, a client device 102 interacts with the service platform 104 to monitor service usage and gather insights into how end-users, such as those associated with the client devices 106A-C, engage with the service 105. Through this interaction, the client device 102 accesses real-time data on metrics such as active user sessions, frequency of feature usage, and overall system performance. This information allows the client device 102, often operated by an organization, administrator, or third party, to track resource utilization, identify trends, pinpoint areas where the service could be optimized or scaled, and as will be described in greater detail below, identify bot-created tenants operating within the cloud-based environment. By leveraging these monitoring capabilities, the organization, represented here as the client device 102, can ensure efficient resource allocation, enhance user experience, and proactively address potential issues within the service 105.

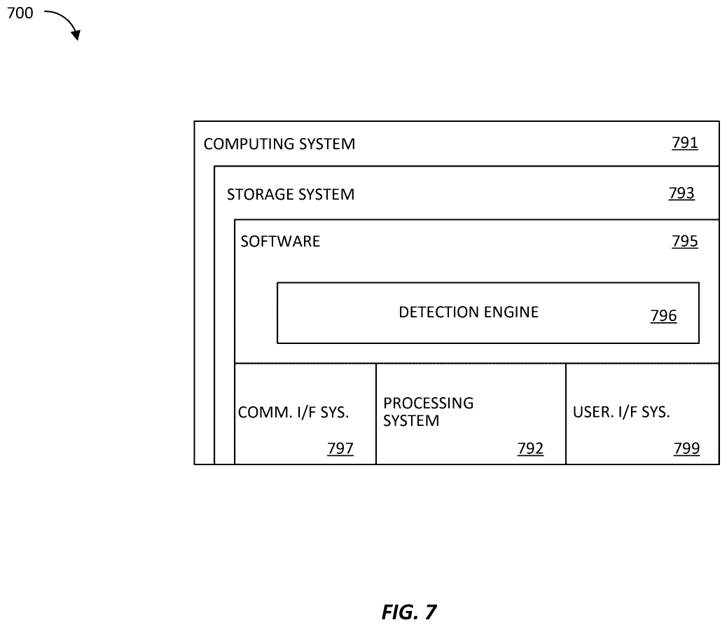

Broadly speaking, the client devices 102 and 106A-C may include personal computers, tablet computers, mobile phones, gaming consoles, wearable devices, Internet of Things (IoT) devices, and any other suitable devices, of which computing apparatus 700 in FIG. 7 is also broadly representative. As such, the client devices 102 and 106A-C communicate with the service platform 104 via one or more networks, including the Internet, intranets, wired and wireless networks, local area networks (LANs), wide area networks (WANs), or any combination thereof. In particular, the client devices 106A-C interact with the service 105 (e.g., a web-based application) through network requests, accessing and utilizing the service's functionality via application programming interfaces (APIs) or user interfaces provided by the service platform 104. Similarly, the client device 102 interacts with the service platform 104 to deploy, monitor, and/or manage the service 105 by configuring resources, setting operational parameters, monitoring performance, and scaling the service 105 as needed to meet consumer demand.

As illustrated, the service 105 is provided within a cloud-based or hybrid environment, where the service platform 104 manages the provisioning of computing resources 108A-C to support its operation. These computing resources 108A-C, which can include virtual machines, storage, processing power, and networking, are allocated by the service platform 104 to ensure the seamless delivery of the service 105 to client devices 106A-C. The computing resources 108A-C are hosted on physical servers 109A-C that are distributed across different regions 110A-C or locations around the globe. The distribution of computing resources 108A-C across multiple regions 110A-C allows for greater flexibility and redundancy, enabling the service platform 104 to allocate computing resources 108A-C based on proximity to the end-users, reducing latency and improving performance. It should be appreciated that while only three regions 110A-C and pools of computing resources 108A-C are illustrated, there may be any number of regions 110A-C and/or groups of computing resources 108A-C. For ease of illustration, the number of regions 110A-C and computing resources 108A-C is limited.

As noted above, the computing resources 108A-C are generally hosted on one or more servers 109A-C, respectively, which serve as the physical infrastructure that powers the provisioned computing services and applications, such as the service 105. As those skilled in the art readily appreciate, the servers 109A-C are specialized computers designed to handle processing, storage, and networking tasks efficiently. Typically, the servers 109A-C consist of CPUs (Central Processing Units), ample amounts of RAM (Random Access Memory), and storage devices such as hard disk drives (HDDs) or solid-state drives (SSDs). In data centers or cloud environments, servers 109A-C are organized into clusters or racks, interconnected through high-speed networks to enable communication and resource sharing. Virtualization technologies further optimize server utilization by allowing multiple virtual machines, instances, or containers to run on a single physical server, maximizing resource efficiency.

In some embodiments, the service platform 104 includes a cloud provider (not shown) that hosts or offers the cloud infrastructure, including the computing resources 108A-C. The cloud provider supplies the foundational infrastructure, such as the servers 109A-C, data centers (not shown), and networking capabilities, upon which the service platform 104 operates. This infrastructure includes the computing resources 108A-C used to form the VMs, storage, and processing power leveraged to support services like service 105. By leveraging the cloud provider's infrastructure, the service platform 104 can efficiently allocate and manage computing resources 108A-C, ensuring that the necessary computing power and storage are available to meet the demands of the client devices 106A-C.

To access the service 105 provided by the service platform 104, users of the client devices 106A-C are required to sign-up by creating a tenant, which acts as an account or license for the service 205. This tenant is essential to establish user identity and access credentials, granting each user secure and personalized entry into the service 205. During the sign-up process, users provide identifying information such as a username, password, phone number, and email address. These identity and access credentials are crucial for creating unique user profiles that allow the service platform 104 to verify each user's identity and maintain secure access. Additional steps, such as multi-factor authentication (MFA), may also be required, prompting users to confirm their identity through a secondary method, like a code sent via SMS or email, which further strengthens account security.

Once a tenant is created, users via the client devices 106A-C can access the service 105 within a structured framework, whether for an organization or a personal setup, such as a household. This tenant-based approach enables an organization or account administrator to centralize access and manage permissions for all connected client devices 106A-C, simplifying resource allocation, security enforcement, and user provisioning. For example, within a corporate tenant, employees access the service 105 through the organization's enterprise license, with individual permissions tailored to each user's role or department. In this example, the users associated with the client device's 106A-C may access the service 205 under the same tenant. In another example, a household or family members may share a subscription under a single tenant, with separate profiles for each user to customize access to productivity tools, media libraries, or other services. In yet another example, a single user, such as the client device 106A accesses the service 205 under its own tenant, meaning that the client device 106A and the client devices 106B-C access the service 205 using different tenants.

Once credentials are established, users on the client devices 106A-C can log in to the service 105 by entering their username and password, gaining access to the service platform's 104 offerings based on their assigned permissions. The service platform 104 manages these credentials securely, often encrypting sensitive information and implementing various access controls to protect user data. Upon successful login, the service platform 104 creates a secure session for the user, enabling seamless access to the service's 105 features, such as productivity applications, email, or other offerings available through the service platform 104. The service platform 104 may also track session duration and user activity for monitoring purposes, helping maintain both the service's 105 security and its performance. By managing user identity and access credentials, the service platform 104 ensures that the client devices 106A-C interact with the service 105 in a secure, personalized, and efficient manner.

In some embodiments, one or more of the client devices 106A-C access the service 105 under a bot-created tenant. Bot-created tenants, unlike those intentionally set up by legitimate users (e.g., professionally or personally), are typically generated automatically by bots or scripts, often without human intervention or authorization. By accessing the service 105 through a bot-created tenant, the client devices 106A-C can perform unauthorized activities, such as consuming excessive resources, exploiting service features, or executing malicious tasks that disrupt regular operations. For instance, bots may use these bot-created tenants to send spam emails, conduct fraudulent transactions, or deploy VMs for cryptocurrency mining. Operating within a bot-created tenant structure allows the client devices 106A-C to mask malicious actions under the guise of a legitimate account, making it harder for standard monitoring systems to detect their presence.

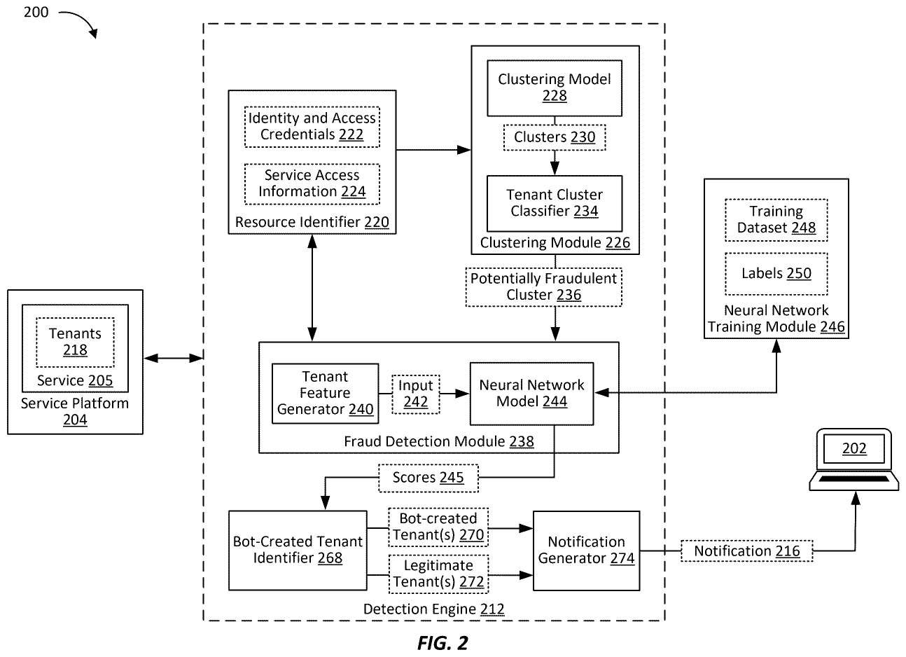

To ensure the security and integrity of the service 105, the environment 100 includes a detection engine 112 for identifying bot-created tenants in real-time. That is, the detection engine 112 is in operational communication with the service platform 104 such to determine whether tenants used by the client devices 106A-C to access the service 105 are legitimate or bot-created. As will be described in greater detail below with respect to FIGS. 2-6, the detection engine 112 identifies resources associated with each tenant and groups these tenants based on shared resources. Resources associated with a tenant, as used herein, include various identity and access credentials associated with a tenant, such as IP address, email address, user information (e.g., username), phone number, and the like. Based on the grouping, the detection engine 112 can identify groups of tenants that share resources. As noted above, bot-created tenants often share resources and as such, identifying a group of tenants sharing a large number of resources can be indicative of bot-created tenants.

However, legitimate tenants are often included within a group of identified tenants that share one or more resources. For instance, if an identified group of tenants including the client devices 106A-C shares an IP address, a legitimate user may also be accessing the service 105 from that same IP address. This overlap makes it challenging to determine whether tenants in the group are fraudulent based solely on shared resources, as this approach can inadvertently flag legitimate tenants as suspicious. To accurately identify fraudulent activity, additional contextual analysis beyond resource sharing is necessary to avoid mistakenly flagging genuine tenants as fraudulent, which can disrupt and negatively impact the user experience.

To determine whether any tenants within a respective group of tenants that share resources are legitimate tenants, the detection engine 112 may analyze each of the tenants within the group. That is, in an embodiment, the detection engine 112 analyzes service access information, along with the identity and access credentials, associated with each tenant in the group to determine which tenant is legitimate and which is likely to be bot-created. For example, the detection engine 112 determines whether each tenant has a license for the service 105. As can be appreciated, a tenant that has a license is more likely to be a legitimate tenant than a tenant accessing the service 105 without a license (e.g., under a free trial). Other service access information can include tenant name, the number of users accessing the service 105 under the tenant, the format and content of domain names associated with the tenant, when the tenant signed-up for the service 105, when the tenant recently accessed the service 105, and the like.

As will be expanded on below, in some embodiments, the detection engine 112 analyzes each tenant within an identified group by submitting information about each tenant into a tenant classifier such as a neural network model. The neural network model is trained based on a training data set containing various tenant, resource, and service access information to generate a score indicating the likelihood that a respective tenant is bot-created or legitimate. By leveraging the neural network model, the detection engine 112 is able to attain a precision of greater than 95% detection of bot-created tenants. As described in greater detail below, the neural network model is trained on a training data set comprises tenant and resource as well as information about whether the tenants are bot created or not, such as label's received from downstream sources.

In some embodiments, once a tenant is identified as a bot-created tenant, the detection engine 112 flags the tenant as such. That is, the detection engine 112 generates a notification that the tenant is fraudulent or likely fraudulent (depending on the configuration of the detection engine 112). As noted above, the client device 102 monitors and manages the service 105, including the performance and security of the service 105. As such, the detection engine 112 is in operable communication with the client device 102 to flag bot-created tenants for the client device 102. In some embodiments, flagging a bot-created tenant includes generating a visual representation 115 of a bot-created tenant, and in some cases, a notification 116. As illustrated, the visual representation 115 and/or notification 116 are provided to a user of the client device 102 via a user interface 114 displayed on the client device 102. In this manner, the user of the client device 102 can interact with the visual representation 115 to further investigate the bot-created tenant and how it relates to other tenants accessing the service 105.

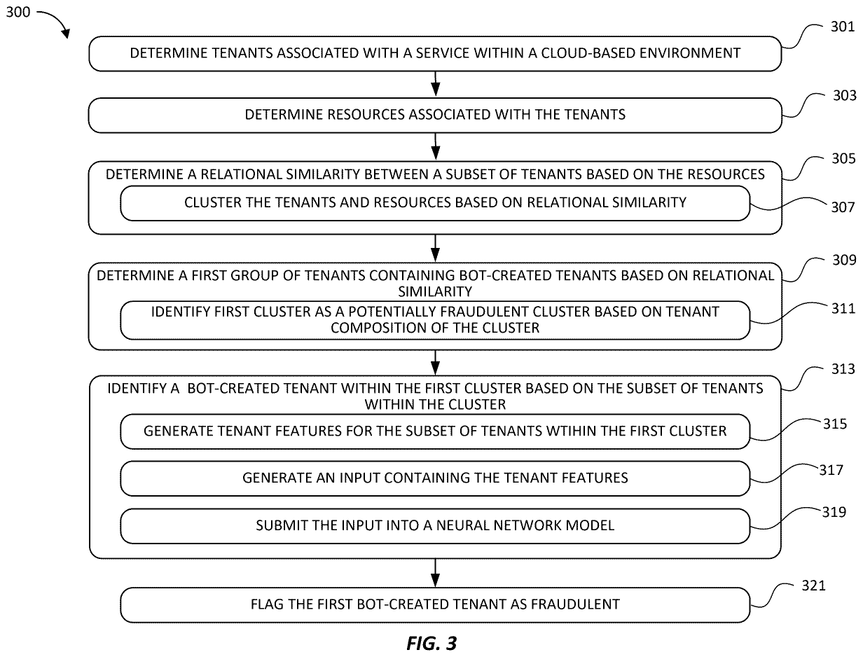

Referring now to FIG. 2, an example cloud-based environment 200 in which a detection engine 212 is leveraged to detect bot-created tenants is illustrated, according to an embodiment herein. For ease of explanation, FIG. 2 is described with reference to FIG. 3, which illustrates a process 300 for providing a detection engine and one or more of its functions, according to an embodiment herein. Although FIG. 3 is described in relation to FIG. 2, it should be appreciated that the process 300 is equally applicable to the remaining figures and components therein.

As illustrated, the detection engine 212 is in operational communication with a service platform 204, which may be the same or similar to the detection engine 112 and the service platform 104, respectively. The service platform 204 provides one or more services 205, which may be the same or similar to the service 105, to tenants 218. Within the environment 200, a tenant 218 is an isolated instance within the shared infrastructure hosted by the service platform 104 that allows one or more users—such as an individual user, organization, or household—to access and utilize the services 205 under a single account or license. Each tenant 218 has its own dedicated environment with specific resources and permissions, which can be centrally managed, ensuring data isolation and tailored access control to the service 205.

As noted above, the detection engine 212 is leveraged by the service platform 204, or in some cases a cloud provider or third party for monitoring and managing the services 205, specifically to detect and identify bot-created tenants from tenants 218. To identify bot-created tenants from the tenants 218, the detection engine 212 initially determines the tenants 218 as associated with the service 205 within the cloud-based environment 200 (301). For example, in an embodiment, the detection engine 212 is leveraged by a client device 202, which may be the same or similar to the client device 102, to monitor the activity and security of the service 205. As such, the detection engine 212 determined a listing of tenants 218 that are associated with the service 205. The tenants 218 that are associated with the service 205 may be tenants that signed-up for the service 205, license the service 205, or otherwise interact with the service 205.

Once the tenants 218 associated with the service 205 are determined, the detection engine 212 determines resources associated with the tenants 218 (303). That is, in the illustrated example, the detection engine 212 includes a resource identifier 220 that determines resources associated with a given tenant of the tenants 218 based on identify and access credentials 222 associated with the tenant 218. In such an example, the resource identifier 220 determines the identify and access credentials 222 associated with the respective tenant 218 by querying the centralized database for the identify and access credentials 222 linked to each tenant. The centralized database may be hosted by the service platform 204 or a third party associated with the service platform 204 for storing tenant information, such as the identify and access credentials 222. Based on the identity and access credentials 222, the resource identifier 220 determines the resources associated with a respective tenant 218. Although the following discussion focuses on the resources of IP address, email address, username, and phone number for ease of discussion, it should be appreciated the other resources are contemplated herein. Examples of other resources include account identifiers, payment information, API keys, domain names, user credentials, and session tokens.

In some embodiments, in addition to the identify and access credentials 222, the resource identifier 220 determines service access information 224 associated with each tenant 218. The service access information 224 includes various information associated with how a respective tenant 218 is accessing the service 205. The service access information 224 includes details such as whether a given tenant 218 has a license for the service 205, the number of users accessing the service 205 under the tenant 218, the tenant's 218 signup date, and the frequency of service 205 access. In additional embodiments, the service access information 224 includes information about the tenant's 218 subscription tier, usage limits or quotas, user roles and permissions, billing cycle and payment status, service-level agreements (SLAs), renewal or expiration dates, support entitlements, geographic location or region of usage, recent activity logs, and/or any custom configurations or integrations enabled for the tenant 218.

Responsive to determining the resources, and in some cases the service access information 224, the detection engine 212 determines a relational similarity between a subset of tenants 218 (305). In some examples a “relational similarity” is where tenants share one or more resources or have one or more resources in common. That is, in some embodiments, the detection engine 212 includes a clustering module 226 that clusters the tenants 218 into one or more clusters 230 based on the resources (307). As illustrated, to cluster the tenants 218, the clustering module 226 includes a clustering model 228 that receives a listing of the tenants 218 and their respective resources, and in some cases, the respective service access information 224, from the resource identifier 220. Based on the listing, the clustering model 228 performs a clustering process to group the tenants 218 into subsets of tenants based on shared or similar resources. That is, the clustering model 228 generates distinct groups or clusters 230 of tenants 218 by analyzing patterns and similarities in the resources, such as IP addresses, email addresses, usernames, and phone numbers.

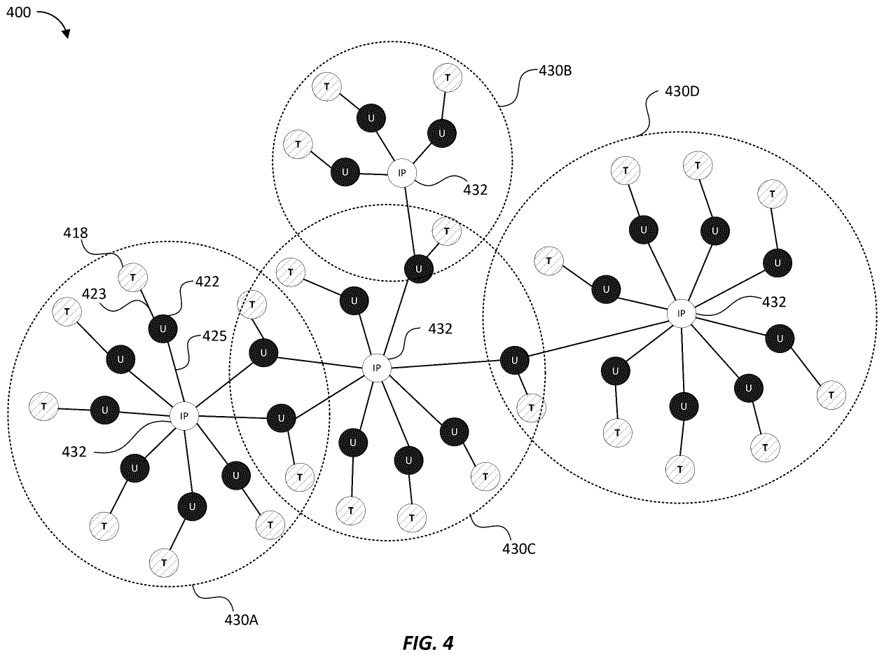

Referring now to FIG. 4, an example visualization 400 of a group of clusters 430A-D is illustrated, according to an embodiment. The visualization 400 illustrates an example grouping of tenants 418, which may be the same or similar to the tenants 218, having relational similarity to each other into the clusters 430A-D. In the illustrated clusters 430A-D, the tenants 418 are grouped based on the similarity of a first resource 422, here users, and a second resource 432, here IP address. In particular, the tenants 418 are grouped based on having users, indicated by the resources 422, accessing the service 205 using the same IP address, indicated by the resources 432. As such, each of the clusters 430A-D are formed based on a centroid indicating that the resource 432 is the shared resource between the nodes of the given cluster.

As shown, each cluster 430A-D is composed of multiple nodes, which may be the tenants 418 or resources 422, 432, that are interconnected to represent a relationship between connected nodes. For example, since the illustrated clusters 430A-D depict the relational similarity between the resources 422, 432 and tenants 418, each tenant 418 is connected via a line 423 indicating that the resource 422 is associated with the tenant 418. Similarly, each of the resources 422 are connected via a line 425 to the resource 432, indicating that the resource 422 is associated with the resource 432, and thereby indicating an association with the tenant 418 and the resource 432. In some examples, a tenant is associated with a resource when the tenant uses the resource to access the service 205. Additionally, as noted above the resource 432 is the centroid for each of the clusters 430A-D, thereby indicating that the IP address is the resource that is shared between the subset of tenants 418 within each cluster.

Returning now to FIG. 2, once the clusters 230, which may be the same or similar to the clusters 430A-D, are generated by the clustering model 228, the clustering module 226 determines whether any of the clusters 230 contain bot-created tenants (309). To make this determination, the clustering module 226 includes a tenant cluster classifier 234. The tenant cluster classifier 234 can identify whether a first group of tenants, such as the cluster 430A, contains bot-created tenants based on a tenant composition of the cluster (311). In an example, the tenant cluster classifier 234 classifies each of the clusters 230 as either a legitimate cluster or a potentially fraudulent cluster.

To determine whether a cluster 230 is a legitimate cluster or a potentially fraudulent cluster 236, the tenant cluster classifier 234 analyzes the resources, and in some cases, the service access information 224 associated with the tenants within the cluster. That is, to detect whether a cluster within the clusters 230 contains bot-created tenants, the tenant cluster classifier 234 analyzes the composition of tenants within the respective cluster. In some cases, the tenant cluster classifier 234 applies one or more rules to determine whether a cluster is a potentially fraudulent cluster 236 or not. It is observed that since resources are typically expensive, tenants created by bots often share resources as a cost saving measure. As such, if a ratio of resources to tenants in a cluster is above a threshold the cluster may be determined to be a potentially fraudulent cluster 236.

For example, the tenant cluster classifier 234 classifies a cluster in which all or a majority (e.g., greater than 60%, 70%, 80%, or 90%) of the tenants have licenses for the service 205 as a legitimate cluster. In contrast, the tenant cluster classifier 234 classifies a cluster in which all or the majority of tenants do not have licenses for the service 205 as a potentially fraudulent cluster 236. Other examples include the tenant cluster classifier 234 classifying a cluster as potentially fraudulent based on geographical location of the IP address or phone number, a similarity in the format or content of a tenant name, phone numbers or email addresses associated with tenants within a given cluster, or the like.

Responsive to identifying a potentially fraudulent cluster 236, the detection engine 212 analyzes each tenant within the potentially fraudulent cluster 236 to identify bot-created tenants (313). That is, the detection engine 212 includes a fraud detection module 238 that identifies one or more bot-created tenants within the potentially fraudulent cluster 236 based on the subset of tenants 218 grouped into the cluster 236. To identify bot-created tenants, as well as legitimate tenants, within the potentially fraudulent cluster 236, the fraud detection module 238 includes a neural network model 244 or other tenant classifier such as a random decision forest or other machine learning classifier. As those skilled in the art appreciate, the neural network model 244 is a computational framework inspired by the structure and function of the human brain that is trained to detect patterns and similar features present within inputs, here tenant features as described below. It should be appreciated, that while the following describes the illustrated neural network model 244 as a heterogenous graph neural network containing a two-tiered structure, other neural network types and architectures, as well as other machine learning (ML) or artificial intelligence (AI) models are contemplated herein. For ease of explanations, the following will first focus on how the neural network model 244 is trained and then how the neural network model 244 is leveraged by the fraud detection module 238 to detect bot-created tenants.

As illustrated, the detection engine 212 is in operable communication with a neural network training module 246. While the neural network training module 246 is illustrated as separate from the detection engine 212, and in particular, the neural network model 244, in some embodiments, the neural network training module 246 may be part of the detection engine 212. As the name suggests, the neural network training module 246 is configured to train the neural network model 244. In particular, the neural network training module 246 trains the neural network model to detect similar tenant features present between the tenants 218 grouped into the potentially fraudulent cluster. To train the neural network model 244, the neural network training module 246 employs a training data set 248 and labels 250. The training data set 248 includes tenant information and respective resources and/or service access information 224 for historical, on-going, or dummy tenants, and the labels 250 identify whether a respective tenant is bot-created or legitimate. The labels 250 may be gathered from downstream clients, such as organizations that identify bot-created tenants within their local environments.

To train the neural network model 244 to distinguish between bot-created tenants and legitimate tenants, the neural network training module 246 feeds the training data set 248 into the neural network model 244, where each entry in the data set 248 corresponds to a unique tenant having respective resources and service access information. By feeding the neural network model 244 entries from the data set 248, the neural network model 244 learns patterns within these resources and service access information to differentiate legitimate tenants from bot-created tenants.

Each data entry in the training data set 248 is paired with a respective label 250, which indicates the true category for that tenant—whether the tenant is legitimate or bot-created. During training, the neural network model 244 uses these labels 250 to adjust its internal parameters (weights and biases) through a process known as backpropagation. With each pass through the data, the neural network model 244 calculates the error between its predictions and the actual labels 250 and uses this feedback to modify its parameters, gradually improving its accuracy in distinguishing between the two groups. As the training progresses, the neural network model 244 becomes better at identifying the patterns and subtle nuances within the resources and service access information that characterize each group.

The neural network training module 246 orchestrates the training process by optimizing various hyperparameters, such as learning rate and batch size, to ensure efficient and effective learning. In some embodiments, the neural network training module 246 also incorporates regularization techniques to prevent overfitting, where the neural network model 244 becomes too attuned to the training data set 248 and fails to generalize well to new data. As the neural network model 244 reaches higher accuracy on the training data set 248, it is evaluated on a validation set to ensure that it performs well on unseen data. By the end of training, the neural network model 244 is able to predict with reasonable confidence whether a tenant is likely a bot-created or a legitimate tenant, based on their respective resources and service access information. Once trained, the neural network model 244 is deployed in real-world applications, such as within the detection engine 212, to enhance the security and integrity of the service 205 by detecting bot-created tenants.

For each of the tenants within the potentially fraudulent cluster 236, the fraud detection module 238 may generate an input 242. The input 242 may be similar to the entry described above with respect to the training process. To generate the input 242, the fraud detection module 238 includes a tenant feature generator 240. For each tenant, the tenant feature generator 240 generates a predefined number of tenant features, such as 5, 10, 15, or 20(315). The tenant features are extracted by the tenant feature generator 240 from the resources and/or the service access information 224. For example, the tenant feature generator 240 extracts a domain name from an email address associated with the tenant as a tenant feature or a number of users associated with a tenant as a tenant feature based on the identity and access credentials 222 and the service access information 224 respectively. Example tenant features include, but are not limited to, user count, licensed user count, tenant name, email domain, email address, username, phone number, IP address, whether the IP address is a VPN, and geolocation data. Based on the tenant features, the tenant feature generator 240 generates the input 242 (317) and submits the input 242 into the neural network model 244 (319).

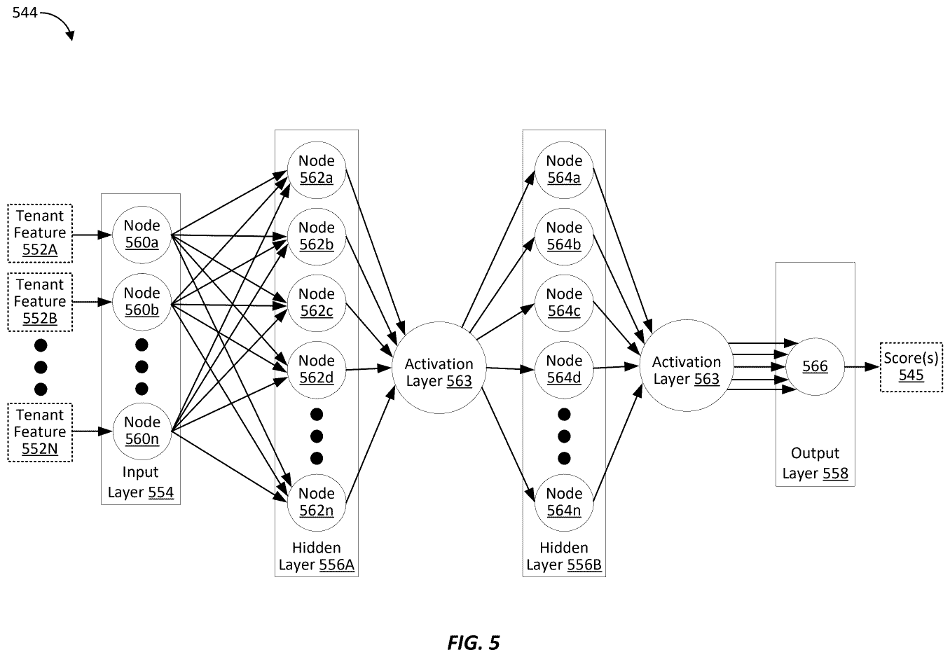

As noted above, in some embodiments, the neural network model 244 is a heterogenous neural network, such as a heterogenous graph neural network model containing a two-tiered structure. Referring now to FIG. 5, an example illustration of a neural network model 544 is illustrated, according to an embodiment herein. As illustrated, the neural network model 544, which may be the same or similar to the neural network model 244, contains an input layer 554, two hidden layers 556A-B, and an output layer 558. As illustrated, each of the layers contains respective nodes, such as the input layer 554 including nodes 560a-n, each of the hidden layers 556A-B including nodes 562a-n, and the output layer 558 including a node 566.

As those skilled in the art readily appreciate, the hidden layers 556A-B are components within the model 244 that transfer received inputs (here the tenant features 552A-N) into more abstract representations, enabling the model 244 to capture complex patterns in the data. In an example, one or both of the hidden layers 556A-B are specialized layers, such as GraphSAGE Convolution (SAGEconv) layers that aggregate information from neighboring nodes 562a-n. In other embodiments, one or both of the hidden layers 556A-B are a Long Short-Term Memory (LSTM) layer, a ChebNet (Chebyshev Convolution) layer, an AGConv (Topology Adaptive Graph Convolution) layer, or an Edge Convolution (EdgeConv) layer.

The neural network model 544, which represents a two-tiered heterogenous neural network model, is designed and trained, as described above, to process the complex data of tenant features 552A-N with a structured, layered architecture. As such, each node within a respective layer processes and transforms the input data, which includes the tenant features 552A-N, to determine whether or not a respective tenant associated with the tenant features 552A-N is a legitimate tenant or a bot-created tenant. Once the tenant feature generator 240 generates the tenant features 522A-N, the tenant features 552A-N are submitted into the input layer 554 as an input, such as the input 242. Each of the nodes 560a-n within the input layer 554 pass a respective tenant feature 552A-N forward to the first hidden layer 556A, where the tenant features 552A-N undergo further analysis and transformation.

As illustrated, the first hidden layer 556A, consists of nodes 562a-n, each dedicated to recognizing foundational patterns in the input data. These nodes 562a-n perform calculations that transform the raw input into more refined representations, capturing initial relationships between characteristics such as similar formats and content of usernames, phone numbers, domain names, number of users per tenant, and the like. In some embodiments, the data output from the first hidden layer 556A then passes through an activation layer 563 before reaching the second hidden layer 556B. In other embodiments, the data output from the first hidden layer 556A passes directly to the second hidden layer 556B.

The activation layer 563 introduces non-linearity into the model 544 by applying an activation function—such as ReLU (Rectified Linear Unit)—to each node's output. That is, the activation layer 563 transforms the received data from the first hidden layer 556A by allowing only positive values to pass through while setting any negative values to zero. The activation layer 563 enables the neural network 544 to learn and represent complex, non-linear relationships in the data, which are often necessary for accurately distinguishing between groups with subtle differences, such as the resources and service access information 224 associated with each tenant 218. In various embodiments, an activation function applied by the activation layer 563 includes one of ReLu, Sigmoid, Tanh (hyperbolic tangent), Leaky ReLu, ELU (Exponential Linear Unit), Swish, Softmax, GELU (Gaussian Error Linear Unit), or SELU (Scaled Exponential Linear Unit).

After passing through the activation layer 563, the data moves into the second hidden layer 556B, where the nodes 562a-n perform further transformations, capturing higher-level and more abstract patterns within the data. This step builds upon the foundational relationships identified in the first hidden layer 556A and refined by the activation layer 563, preparing the information for the final decision-making step. As illustrated, the output from the second hidden layer 556B may be passed through a second activation layer 563, depending on the specific architecture of the model 544, before the output is provided to the output layer 558.

Responsive to receiving the data from the second hidden layer 556B, or in some cases the activation layer 563, the output layer 558, containing the node 566, aggregates the refined insights from the previous layers 556A-B, and optionally the activation layers 563, and generates a score 545 indicating whether a likelihood that a respective tenant is a legitimate tenant or a bot-created tenant based on the input tenant features 552A-N.

In some embodiments, the neural network model 544 illustrated herein achieves at least 98% precision, in some cases greater than 99% precision, while maintaining a recall of at least 65%, thereby indicating the model's 544 ability to correctly identify positive instances while minimizing false positives. Achieving a precision greater than 98% demonstrates the model's 544 ability to avoid false alarms; however, balancing this with a high recall—the model's 544 capacity to capture all true positives—requires careful tuning. Increasing recall often involves widening the scope to detect more true positives, which can introduce occasional false positives, while boosting precision may involve stricter criteria that could miss some true positives. As such, training the model 544 becomes a balancing act, iteratively adjusting parameters, optimizing the loss function, and potentially re-sampling data to fine-tune both metrics until a balance between precision and recall is met. This dynamic interplay between precision and recall shapes the model 544 to be both accurate and comprehensive in its predictions (e.g., scores 545).

Returning now to FIG. 2, responsive to receiving the input 242, the neural network model 244 generates the scores 245, which may be the same or similar to the scores 545, for each respective tenant within the potentially fraudulent cluster 236. The scores 245 are then fed to a bot-created tenant identifier 268 which determines whether or not a given tenant is bot-created based on the scores 245. For example, if a score 245 is a probability that a tenant is bot-created, a score 245 that is greater than 80% may be read by the bot-created tenant identifier 268 as a bot-created tenant. In other embodiments, the scores 245 are a binary indication of whether a respective tenant is legitimate or bot-created. For example, for a given tenant, the neural network model 244 generates either a zero or a one indicating whether or not the tenant is legitimate or bot-created.

Based on the scores 245, the bot-created tenant identifier 268 identifies one or more bot-created tenants 270 within the potentially fraudulent cluster 236. In some cases, the bot-created tenant identifier 268 also identifies one or more legitimate tenants 272 within the potentially fraudulent cluster 236. As described above, it is equally important to identify the legitimate tenants 272 within a cluster containing bot-created tenants 270 such to not disrupt the on-going customer experience with the service 205.

Responsive to identifying the bot-created tenants 270, and in some cases the legitimate tenants 272, the detection engine 212 flags the bot-created tenants 270 (321). That is, the detection engine 212 includes a notification generator 274 that generates a notification 216 flagging an identified bot-created tenant 270. As described above, services like the service 205 often have dedicated individuals or organizations monitoring and managing operations to ensure a high-quality user experience and maintain ongoing security. As such, these managers, such as a user associated with the client device 202, continuously scan and monitor for potential security issues, such as bot-created tenants 270. As such, the detection engine 212, responsive to detecting the bot-created tenants 270 promptly notifies the managing personnel through automated alerts, such as the notification 216 which may include an email, a SMS notification, or a dashboard update in real time. In some embodiments, the notification 216 is generated as part of a dashboard update, such as part of a visual representation of the tenant composition for the service 205. In such cases, the detection engine 212 also generates a visual representation, such as described below. In some cases, the notification generator triggers an automated instruction to isolate the bot-created tenants 270. That is, the detection engine 212 may trigger the service platform 204 to isolate the bot-created tenants 270 to segregate them and limit their access to the service 205. By limiting the bot-created tenants'270 interactions with the service platform 204 prevents any potentially malicious interactions that the tenants 270 may take with respect to the service 205.

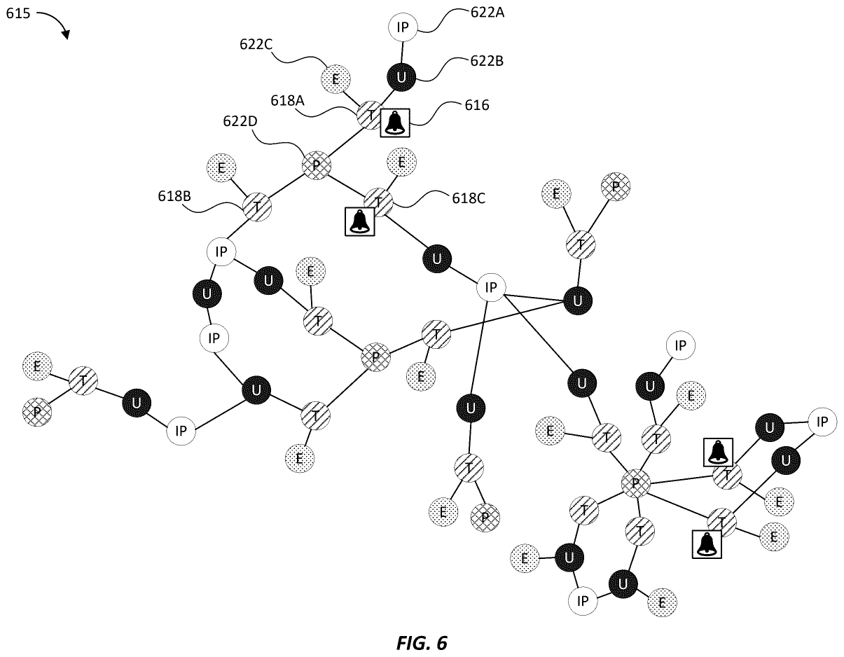

Referring now to FIG. 6, an example visual representation 600 identifying a bot-created tenant is illustrated, according to an embodiment herein. The visual representation 600 provides a visual depiction of how various resources 622A-D are related to a respective tenant 618A and a notification 616 indicating that the tenant 618A is flagged as a bot-created tenant. In the illustrated depiction, the white circle labeled IP, such as the resource 622A indicates an IP address, the black circle labeled U, such as the resource 622B indicates a user, the dotted circle labeled E, such as the resource 622C indicates an email address, the hashed circle labeled B, such as the resource 622D indicates a phone number, and the slashed circle labeled T, such as the tenant 618A indicates a tenant.

In some embodiments, the visual representation 600 is generated by the detection engine 212 and displayed to a user via a user interface on a client device, such as the client device 202. The visual representation 600 illustrates how various tenants, such as the tenant 618A, tenant 618B, and tenant 618C share a resource 622D. Based at least on the sharing of the resource 622D, the detection engine 212 determined that the tenants A and C are bot-created. As such, the detection engine 212 generates the notification 616 for each of the tenants. The notification 616, which may be the same or similar to the notification 216, is generated by the detection engine 212 following one or more of the above described steps for detecting bot-created tenants.

By providing the visual representation 600 to administrators or managers, such as via a display on the client device 202, the detection engine 212 allows for quick identification of patterns and clusters of bot-created tenant activity, aiding organizations in spotting trends or abnormal spikes in account creation that may indicate malicious activity. Additionally, the notifications 616 offer real-time alerts, enabling prompt responses to potential security threats. Overall, the detection engine 212 enables organizations, administrators, or monitoring personnel to act swiftly, reducing the risk of unauthorized access, preserving the system's computing resources, and ensuring that legitimate users experience uninterrupted service.

Referring to FIG. 7, FIG. 7 illustrates a computing apparatus 791 that may be used for providing a detection engine and related functions, as described herein. For example, the client devices 102, 106A-C, or 202 may be or include the computing apparatus 791. As illustrated, the computing apparatus 791 includes a processing system 792 that includes a microprocessor and other circuitry that retrieves and executes software 795 from storage system 793. The processing system 792 may be implemented within a single processing device but may also be distributed across multiple processing devices or sub-systems that cooperate in executing program instructions. Examples of the processing system 792 include general purpose central processing units, graphical processing units, application specific processors, and logic devices, as well as any other type of processing device, combinations, or variations thereof.

The storage system 793 may comprise any computer-readable storage media or medium readable by processing system 792 and capable of storing software 795. The storage system 793 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 793 may also include computer readable communication media over which at least some of the software 795 may be communicated internally or externally. The storage system 793 may be implemented as a single storage device but may also be implemented across multiple storage devices or sub-systems co-located or distributed relative to each other. The storage system 793 may comprise additional elements, such as a controller capable of communicating with the processing system 792 or possibly other systems.

The software 795 (including detection engine process 796) may be implemented in program instructions and among other functions may, when executed by the processing system 792, direct the processing system 792 to operate as described with respect to the various operational scenarios, sequences, and processes illustrated herein. For example, the software 795 may include program instructions for implementing a detection engine and related functions, such as the process 300, as described herein. In some cases, the software 795 may cause one or more features of the detection engine process 796 to provide or display respective components to a user via a user interface system 799 inoperable communication with a client device, such as the client device 102 or 202.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 795 may include additional processes, programs, or components, such as operating system software, virtualization software, or other application software. The software 795 may also comprise firmware or some other form of machine-readable processing instructions executable by the processing system 792.

In general, the software 795 may, when loaded into the processing system 792 and executed, transform a suitable apparatus, system, or device (of which computing apparatus 791 is representative) overall from a general-purpose computing system into a special-purpose computing system customized to generate features, functionality, and user experiences provided by the detection engine. Indeed, encoding the software 795 on the storage system 793 may transform the physical structure of the storage system 793. The specific transformation of the physical structure may depend on various factors in different implementations of this description. Examples of such factors may include, but are not limited to, the technology used to implement the storage media of the storage system 793 and whether the computer-storage media are characterized as primary or secondary storage, as well as other factors.

For example, if the computer readable storage media are implemented as semiconductor-based memory, the software 795 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 797 may include communication connections and devices that allow for communication with other computing systems (not shown) over communication networks (not shown). Examples of connections and devices that together allow for inter-system communication may include network interface cards, antennas, power amplifiers, radio frequency (RF) circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing apparatus 791 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as programmable logic controllers (PLCs), programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of which may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing a detection engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage media; a detection engine comprising processor-executable instructions stored on the computer-readable storage media; and a processor coupled to the computer-readable storage media and configured to execute the processor-executable instructions, wherein the processor-executable instructions, when executed by the processor, direct the computing apparatus, to at least: determine a plurality of tenants within a cloud-based environment; determine a plurality of resources corresponding to the plurality of tenants, wherein a resource within the plurality of resources corresponds to a respective tenant within the plurality of tenants; generate one or more clusters from the plurality of resources, wherein a cluster within the one or more clusters comprises a plurality of nodes and one or more lines representing relationships between nodes; detect that a first cluster of the one or more clusters comprises one or more bot-created tenants, wherein the first cluster comprises a first subset of tenants of the plurality of tenants; and identify a first bot-created tenant within the first cluster using the first subset of tenants.

Example 2 is the computing apparatus of any previous or subsequent Example, wherein the processor-executable instructions to identify the first bot-created tenant within the first cluster using the first subset of tenants, when executed by the processor, further direct the computing apparatus to: generate a plurality of tenant features for the first subset of tenants; input the plurality of tenant features for the first subset of tenants as an input into a neural network model; receive a score for one or more tenants within the first subset of tenants as an output from the neural network model; and determine the first bot-created tenant from a respective score received from the neural network model.

Example 3 is the computing apparatus of any previous or subsequent Example, wherein: the processor-executable instructions to detect that the first cluster of the one or more clusters comprises one or more bot-created tenants, when executed by the processor, further direct the computing apparatus to: submit the one or more clusters as input into a cluster classifier; and determine, via the cluster classifier, that a first cluster of the one or more clusters comprises a plurality of suspected bot-created tenants; and the processor-executable instructions to identify the first bot-created tenant within the first cluster from the first subset of tenants, when executed by the processor, further direct the computing apparatus to: identify, via a neural network classifier, a subset of bot-created tenants from the plurality of suspected bot-created tenants, wherein the subset of bot-created tenants comprises the first bot-created tenant.

Example 4 is the computing apparatus of any previous or subsequent Example, wherein the processor-executable instructions to determine the plurality of resources corresponding to the plurality of tenants, when executed by the processor, further direct the computing apparatus to: determine one or more identity and access credentials for a tenant within the plurality of tenants for accessing a service within the cloud-based environment; and determine service access information for the tenant using the one or more identity and access credentials.

Example 5 is the computing apparatus of any previous or subsequent Example, wherein the processor-executable instructions, when executed by the processor, further direct the computing apparatus to: determine at least one legitimate tenant within the first subset of tenants of the first cluster.

Example 6 is the computing apparatus of any previous or subsequent Example, wherein the processor-executable instructions to generate the one or more clusters, when executed by the processor, further direct the computing apparatus to: execute a clustering algorithm on an input comprising the plurality of tenants and the plurality of resources; generate the one or more clusters from the input, wherein the plurality of tenants and the plurality of resources are represented as nodes within the one or more clusters; and generate a centroid for each of the one or more clusters, wherein a respective centroid is determined using a relational position of the respective nodes within the cluster.

Example 7 is a method comprising: determining, by a detection engine, a plurality of tenants within a cloud-based or hybrid environment; determining, by the detection engine, a plurality of resources associated with the plurality of tenants, wherein a resource within the plurality of resources corresponds to a respective tenant within the plurality of tenants; determining, by the detection engine, a relational similarity between a first subset of tenants, wherein: the plurality of tenants comprises the first subset of tenants; and the first subset of tenants comprises one or more shared resources; determining, by the detection engine, that the first subset of tenants comprises a plurality of bot-created tenants according to their relational similarity; submitting, by the detection engine, the first subset of tenants as input into a neural network model; and identifying, by the detection engine, at least one legitimate tenant within the first subset of tenants from an output from the neural network model.

Example 8 is the method of any previous or subsequent Example, wherein the plurality of resources comprise identity and access credentials used by a respective tenant to access a service within the cloud-based or hybrid environment.

Example 9 is the method of any previous or subsequent Example, wherein submitting, by the detection engine, the first subset of tenants as input into the neural network model comprises: determining, by the detection engine, service access information associated with a first tenant within the first subset of tenants; generating, by the detection engine, a plurality of tenant features from service access information for the first tenant; and submitting, by the detection engine, the plurality of tenant features for the first tenant as input into the neural network model.

Example 10 is the method of any previous or subsequent Example, wherein determining, by the detection engine, the relational similarity between the first subset of tenants using the plurality of resources comprises: generating, by the detection engine, a plurality of clusters according to the plurality of resources, wherein: the plurality of tenants is grouped into the plurality of clusters; a cluster comprises a plurality of nodes connected by lines, each node representing a tenant or a resource, and each line connecting a tenant to a resource used by the tenant, such that nodes in a cluster have relational similarity to one another through shared ones of the resources; and determining, by the detection engine, a first cluster comprising the plurality of bot-created tenants from the relational similarity between the nodes within the first cluster, wherein the first cluster comprises the first subset of tenants.

Example 11 is the method of any previous or subsequent Example, wherein responsive to submitting the first subset of tenants to the neural network model the method further comprises: identifying, by the detection engine, a subset of bot-created tenants within the first subset using the output from the neural network model, wherein the plurality of bot-created tenants comprises the subset of bot-created tenants; and flagging, by the detection engine, the subset of bot-created tenants as fraudulent.

Example 12 is the method of any previous or subsequent Example, wherein the neural network model comprises a heterogenous graph neural network comprising a two-tier architecture having a precision of greater than 98%.

Example 13 is the method of any previous or subsequent Example, wherein submitting, by the detection engine, the first subset of tenants as input into the neural network model comprises: extracting, by the detection engine, a plurality of tenant features from the first subset of tenants; generating, by the detection engine, an input comprising the plurality of tenant features from the first subset of tenants; and submitting, by the detection engine, the input as input into the neural network model.

Example 14 is the method of any previous or subsequent Example, wherein the method further comprises: generating, by the detection engine, a visual representation of the first subset using the relational similarity; identifying, by the detection engine, a subset of bot-created tenants within the first subset from the visual representation; and providing, by the detection engine, the visual representation to a client device for display via a user interface.

Example 15 is a computer readable storage media comprising processor-executable instructions configured to cause a processor to: determine, by a detection engine, a plurality of tenants within a cloud-based or hybrid environment; determine, by the detection engine, a plurality of resources corresponding to the plurality of tenants, wherein a resource within the plurality of resources corresponds to a respective tenant within the plurality of tenants; submit, by the detection engine, a first subset of tenants and a first subset of resources corresponding to the first subset of tenants to a neural network model, wherein the plurality of tenants comprise the first subset of tenants and the plurality of resources comprise the first subset of resources; identify, by the detection engine, a first bot-created tenant within the first subset of tenants using an output from the neural network model; and flag, by the detection engine, the first bot-created tenant as fraudulent.

Example 16 is the computer readable storage media of any previous or subsequent Example, wherein the processor-executable instructions to submit, by the detection engine, the first subset of tenants and the first subset of resources corresponding to the first subset of tenants to the neural network model cause the processor to further execute processor-executable instructions stored in the computer readable storage media to: generate, by the detection engine, a plurality of tenant features for the first subset of tenants from service access information associated with a respective tenant within the first subset of tenants; generate, by the detection engine, an input comprising the plurality of tenant features and the first subset of resources corresponding to the first subset of tenants; and submit, by the detection engine, the input as input into the neural network model.

Example 17 is the computer readable storage media of any previous or subsequent Example, wherein the processor-executable instructions cause the processor to further execute processor-executable instructions stored in the computer readable storage media to: classify, by the detection engine, the plurality of tenants into one or more tenant classifications, wherein the one or more tenant classifications indicate a relational similarity between tenants and resources within a respective tenant classification; and determine, by the detection engine, the first subset of tenants using the tenant classifications.

Example 18 is the computer readable storage media of any previous or subsequent Example, wherein the output from the neural network model comprises a score and the processor-executable instructions to identify, by the detection engine, a first bot-created tenant within the first subset of tenants using an output from the neural network model cause the processor to further execute processor-executable instructions stored in the computer readable storage media to: receive, by the detection engine, a plurality of scores as output from the neural network model, wherein a score of the plurality of scores corresponds to a respective tenant from the first subset of tenants; and determine, by the detection engine, that a first tenant within the first subset of tenants is bot-created using a respective score received from the neural network model, wherein the first tenant comprises the first bot-created tenant.

Example 19 is the computer readable storage media of any previous or subsequent Example, wherein the processor-executable instructions to determine, by the detection engine, the plurality of resources corresponding to the plurality of tenants cause the processor to further execute processor-executable instructions stored in the computer readable storage media to: determine, by the detection engine, one or more identity and access credentials for a tenant within the plurality of tenants for accessing a service within the cloud-based or hybrid environment.

Example 20 is the computer readable storage media of any previous or subsequent Example, wherein the processor-executable instructions to flag, by the detection engine, the first bot-created tenant as fraudulent cause the processor to further execute processor-executable instructions stored in the computer readable storage media to: generate, by the detection engine, a visual representation of a plurality of bot-created tenants within the first subset of tenants, wherein the plurality of bot-created tenants comprises the first bot-created tenant; and transmit, by the detection engine, the visual representation to a client device for display via a user interface.

What is claimed is:

1. A computing apparatus comprising:
a computer-readable storage media;
a detection engine comprising processor-executable instructions stored on the computer-readable storage media; and
a processor coupled to the computer-readable storage media and configured to execute the processor-executable instructions, wherein the processor-executable instructions, when executed by the processor, direct the computing apparatus, to at least:
determine a plurality of tenants within a cloud-based environment;
determine a plurality of resources corresponding to the plurality of tenants, wherein a resource within the plurality of resources corresponds to a respective tenant within the plurality of tenants;
generate one or more clusters from the plurality of resources, wherein a cluster within the one or more clusters comprises a plurality of nodes and one or more lines representing relationships between nodes;
detect that a first cluster of the one or more clusters comprises one or more bot-created tenants, wherein the first cluster comprises a first subset of tenants of the plurality of tenants; and
identify a first bot-created tenant within the first cluster using the first subset of tenants.

2. The computing apparatus of claim 1, wherein the processor-executable instructions to identify the first bot-created tenant within the first cluster using the first subset of tenants, when executed by the processor, further direct the computing apparatus to:
generate a plurality of tenant features for the first subset of tenants;
input the plurality of tenant features for the first subset of tenants as an input into a neural network model;
receive a score for one or more tenants within the first subset of tenants as an output from the neural network model; and
determine the first bot-created tenant from a respective score received from the neural network model.

3. The computing apparatus of claim 1, wherein:
the processor-executable instructions to detect that the first cluster of the one or more clusters comprises one or more bot-created tenants, when executed by the processor, further direct the computing apparatus to:
submit the one or more clusters as input into a cluster classifier; and
determine, via the cluster classifier, that a first cluster of the one or more clusters comprises a plurality of suspected bot-created tenants; and
the processor-executable instructions to identify the first bot-created tenant within the first cluster from the first subset of tenants, when executed by the processor, further direct the computing apparatus to:
identify, via a neural network classifier, a subset of bot-created tenants from the plurality of suspected bot-created tenants, wherein the subset of bot-created tenants comprises the first bot-created tenant.

4. The computing apparatus of claim 1, wherein the processor-executable instructions to determine the plurality of resources corresponding to the plurality of tenants, when executed by the processor, further direct the computing apparatus to:
determine one or more identity and access credentials for a tenant within the plurality of tenants for accessing a service within the cloud-based environment; and
determine service access information for the tenant using the one or more identity and access credentials.

5. The computing apparatus of claim 1, wherein the processor-executable instructions, when executed by the processor, further direct the computing apparatus to:
determine at least one legitimate tenant within the first subset of tenants of the first cluster.

6. The computing apparatus of claim 1, wherein the processor-executable instructions to generate the one or more clusters, when executed by the processor, further direct the computing apparatus to:
execute a clustering algorithm on an input comprising the plurality of tenants and the plurality of resources;
generate the one or more clusters from the input, wherein the plurality of tenants and the plurality of resources are represented as nodes within the one or more clusters; and
generate a centroid for each of the one or more clusters, wherein a respective centroid is determined using a relational position of the respective nodes within the cluster.

7. A method comprising:
determining, by a detection engine, a plurality of tenants within a cloud-based or hybrid environment;
determining, by the detection engine, a plurality of resources associated with the plurality of tenants, wherein a resource within the plurality of resources corresponds to a respective tenant within the plurality of tenants;
determining, by the detection engine, a relational similarity between a first subset of tenants, wherein:
the plurality of tenants comprises the first subset of tenants; and
the first subset of tenants comprises one or more shared resources;
determining, by the detection engine, that the first subset of tenants comprises a plurality of bot-created tenants according to their relational similarity;
submitting, by the detection engine, the first subset of tenants as input into a neural network model; and
identifying, by the detection engine, at least one legitimate tenant within the first subset of tenants from an output from the neural network model.

8. The method of claim 7, wherein the plurality of resources comprise identity and access credentials used by a respective tenant to access a service within the cloud-based or hybrid environment.

9. The method of claim 7, wherein submitting, by the detection engine, the first subset of tenants as input into the neural network model comprises:
determining, by the detection engine, service access information associated with a first tenant within the first subset of tenants;
generating, by the detection engine, a plurality of tenant features from service access information for the first tenant; and
submitting, by the detection engine, the plurality of tenant features for the first tenant as input into the neural network model.

10. The method of claim 7, wherein determining, by the detection engine, the relational similarity between the first subset of tenants using the plurality of resources comprises:
generating, by the detection engine, a plurality of clusters according to the plurality of resources, wherein:
the plurality of tenants is grouped into the plurality of clusters;
a cluster comprises a plurality of nodes connected by lines, each node representing a tenant or a resource, and each line connecting a tenant to a resource used by the tenant, such that nodes in a cluster have relational similarity to one another through shared ones of the resources; and
determining, by the detection engine, a first cluster comprising the plurality of bot-created tenants from the relational similarity between the nodes within the first cluster, wherein the first cluster comprises the first subset of tenants.

11. The method of claim 7, wherein responsive to submitting the first subset of tenants to the neural network model the method further comprises:
identifying, by the detection engine, a subset of bot-created tenants within the first subset using the output from the neural network model, wherein the plurality of bot-created tenants comprises the subset of bot-created tenants; and
flagging, by the detection engine, the subset of bot-created tenants as fraudulent.

12. The method of claim 7, wherein the neural network model comprises a heterogenous graph neural network comprising a two-tier architecture having a precision of greater than 98%.

13. The method of claim 7, wherein submitting, by the detection engine, the first subset of tenants as input into the neural network model comprises:
extracting, by the detection engine, a plurality of tenant features from the first subset of tenants;
generating, by the detection engine, an input comprising the plurality of tenant features from the first subset of tenants; and
submitting, by the detection engine, the input as input into the neural network model.

14. The method of claim 7, wherein the method further comprises:
generating, by the detection engine, a visual representation of the first subset using the relational similarity;
identifying, by the detection engine, a subset of bot-created tenants within the first subset from the visual representation; and
providing, by the detection engine, the visual representation to a client device for display via a user interface.

15. A computer readable storage media comprising processor-executable instructions configured to cause a processor to:
determine, by a detection engine, a plurality of tenants within a cloud-based or hybrid environment;
determine, by the detection engine, a plurality of resources corresponding to the plurality of tenants, wherein a resource within the plurality of resources corresponds to a respective tenant within the plurality of tenants;
submit, by the detection engine, a first subset of tenants and a first subset of resources corresponding to the first subset of tenants to a neural network model, wherein the plurality of tenants comprise the first subset of tenants and the plurality of resources comprise the first subset of resources;
identify, by the detection engine, a first bot-created tenant within the first subset of tenants using an output from the neural network model; and
flag, by the detection engine, the first bot-created tenant as fraudulent.

16. The computer readable storage media of claim 15, wherein the processor-executable instructions to submit, by the detection engine, the first subset of tenants and the first subset of resources corresponding to the first subset of tenants to the neural network model cause the processor to further execute processor-executable instructions stored in the computer readable storage media to:
generate, by the detection engine, a plurality of tenant features for the first subset of tenants from service access information associated with a respective tenant within the first subset of tenants;
generate, by the detection engine, an input comprising the plurality of tenant features and the first subset of resources corresponding to the first subset of tenants; and
submit, by the detection engine, the input as input into the neural network model.

17. The computer readable storage media of claim 15, wherein the processor-executable instructions cause the processor to further execute processor-executable instructions stored in the computer readable storage media to:
classify, by the detection engine, the plurality of tenants into one or more tenant classifications, wherein the one or more tenant classifications indicate a relational similarity between tenants and resources within a respective tenant classification; and
determine, by the detection engine, the first subset of tenants using the tenant classifications.

18. The computer readable storage media of claim 15, wherein the output from the neural network model comprises a score and the processor-executable instructions to identify, by the detection engine, a first bot-created tenant within the first subset of tenants using an output from the neural network model cause the processor to further execute processor-executable instructions stored in the computer readable storage media to:
receive, by the detection engine, a plurality of scores as output from the neural network model, wherein a score of the plurality of scores corresponds to a respective tenant from the first subset of tenants; and
determine, by the detection engine, that a first tenant within the first subset of tenants is bot-created using a respective score received from the neural network model, wherein the first tenant comprises the first bot-created tenant.

19. The computer readable storage media of claim 15, wherein the processor-executable instructions to determine, by the detection engine, the plurality of resources corresponding to the plurality of tenants cause the processor to further execute processor-executable instructions stored in the computer readable storage media to:
determine, by the detection engine, one or more identity and access credentials for a tenant within the plurality of tenants for accessing a service within the cloud-based or hybrid environment.

20. The computer readable storage media of claim 15, wherein the processor-executable instructions to flag, by the detection engine, the first bot-created tenant as fraudulent cause the processor to further execute processor-executable instructions stored in the computer readable storage media to:
generate, by the detection engine, a visual representation of a plurality of bot-created tenants within the first subset of tenants, wherein the plurality of bot-created tenants comprises the first bot-created tenant; and
transmit, by the detection engine, the visual representation to a client device for display via a user interface.
